(19) United States
(12) Patent Application Publication
(10) Pub. No.: US 2008/0078735 A1
(43) Pub. Date: Apr. 3, 2008

(54) HOISTING DEVICE

(75) Inventor: Eric LETELLIER, Charleville (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SEFAC SOCIETE ANONYME, Montherme (FR)

(21) Appl. No.: 11/861,735

(22) Filed: Sep. 26, 2007

(30) Foreign Application Priority Data
Sep. 29, 2006 (FR) 0654026
Oct. 19, 2006 (FR) 0654354

(51) Int. Cl. F16B 21/16

(52) U.S. Cl. 212/180; 411/411

(57) ABSTRACT

The invention relates to a hoisting device (1), in particular for a vehicle, including a substantially vertical column forming a frame (2) and lifting means (6) movable alongside said column (2) under the action of the control, by adequate driving means (12), to cause a threaded rod (9) to rotate and a nut (13) integral with said movable lifting means (6) on which the load to be lifted is designed capable of resting to move along the latter.

In this hoisting device, the threaded rod (9) includes, at its lower end (14), a removable extension ferrule (15).

### BACKGROUND OF THE INVENTION

(1) Field of the Invention

The present invention relates to a hoisting device, in particular for a vehicle, including a substantially vertical column forming a frame and lifting means movable alongside said column under the action of the control, by adequate driving means, to cause a threaded rod to rotate and a nut integral with a carriage on which rests the load to be lifted to move along the latter.

The present invention will find its application in the field of the handling devices, in particular of the hoisting devices, namely for vehicles.

(2) Description of the Prior Art

There are already known hoisting devices meeting the above description, in particular from CH-635.555.

In particular, such hoisting devices are in the form of a vertical column forming a frame resting on the floor through a base plate, often provided with rolling means aimed at facilitating the displacement of this column.

More particularly, the latter defines a rail along which are designed capable of moving lifting means in the form of a movable carriage provided with guiding means and adapted rolling means.

The control to cause the carriage to move is achieved through the rotation of a vertical threaded rod, which said column contains and on which is fitted a nut made integral with said movable carriage.

In order to avoid buckling phenomena under the stress of the lifted load, the threaded rod is mounted hung at the level of the column head, which furthermore receives the electric motor for driving same in rotation.

Obviously, for safety reasons and irrespective of the damage suffered, it is advisable to avoid the lifted load from falling down.

Many measures have been taken for a safety nut to be capable of taking over in the event of breaking of the nut through which the carriage defining the lifting means is made integral with the screw.

Likewise, measures have been taken to avoid this fall in the event of breaking of the screw itself. In this respect, one understands that this breaking can necessarily occur only above or at the level of the lifted load, knowing that this screw usually has its most important brittle point at the level of its maintaining in rotation at the level of the column head.

As a matter of fact, in order to prevent the fall, the screw substantially extends over the full height of the lifting column and often maintains only a very short distance, which can be described as functional, between its lower end and the floor. Therefore, in the event of breaking of the screw, the load can fall only over a distance corresponding merely to this functional backlash.

It should be noticed, in this respect, that the standards generally applicable in this field authorize a drop height limited to 5 cm. Thus, in theory, the threaded rod could maintain, with respect to the floor, a maximum distance of 5 cm.

Irrespective of the situation, this design laid on by the safety requirements in this field of the hoisting devices in the form of a column requires, in the event of replacement of the wearing part, which the lifting nut represents, the complete dismantling of the threaded rod.

Indeed, the connection of this threaded rod to the column head and the small space, which its lower end compulsorily maintains with respect to the floor, even to the base plate, prevent this removal of the nut.

Actually, the specialist in the art has always suffered from this constraint during the dismantling of the screw for replacing the nut, since he thought that there was no other alternative for complying with the applicable safety requirements.

### SUMMARY OF THE INVENTION

Through the present invention, one has been capable of avoiding this preconception. Thus, one could see that, in its lower end portion, said threaded rod does not act as a screw, since it does not have to cooperate with the nut. Indeed, because of the dimensions related to the carriage forming the lifting means, this nut remains at a certain height along this threaded rod, even when the load is placed on the floor by said lifting means.

Thus, within the framework of an inventive step one has been able to observe that the only purpose of this lower portion of the threaded rod is to extend the latter in order to avoid, in the event of breaking, the fall of the lifted load.

Finally, through a second inventive step one has thought that this function of extending the threaded rod was likely to be provided by an extension ferrule removably inserted onto the lower end of this threaded rod, so that, after removing said ferrule, there is sufficient room permitting to remove the nut for its replacement.

To this end, the invention relates to a hoisting device, in particular for a vehicle, including a substantially vertical column forming a frame and lifting means movable alongside said column under the action of the control, by adequate driving means, to cause a threaded rod to rotate and a nut integral with said movable lifting means on which the load to be lifted is designed capable of resting, to move along the latter, wherein the threaded rod includes, at its lower end, a removable extension ferrule.

The advantages resulting from the present invention obviously consist in a substantial time saving for replacing, if necessary, the nut.

It should also be added that this extension ferrule can be defined and dimensioned so as to ensure a better support of the load in the event of breaking of the threaded rod.

If, in such a situation of breaking, the lifted weight would happen to rest on the floor, until now through the threaded rod, through providing it with an extension ferrule, the latter would ensure this function of supporting the load. However, since this ferrule does not act as a screw, it can be dimensioned differently, in order to ensure, with an increased effectiveness, this supporting the load in the event of breaking.

The present invention will be better understood when reading the following description, with reference to the attached drawing.

### BRIEF DESCRIPTION OF THE DRAWINGS

FIG. 1 schematically shows a hoisting device, such as a column, according to the invention;

FIG. 2 schematically shows the lower end of the threaded rod provided with the extension ferrule designed removable;

FIG. 3 is a schematic cross-sectional view of the extension ferrule inserted onto the lower end of said threaded rod.

### DETAILED DESCRIPTION OF THE PREFERRED EMBODIMENTS

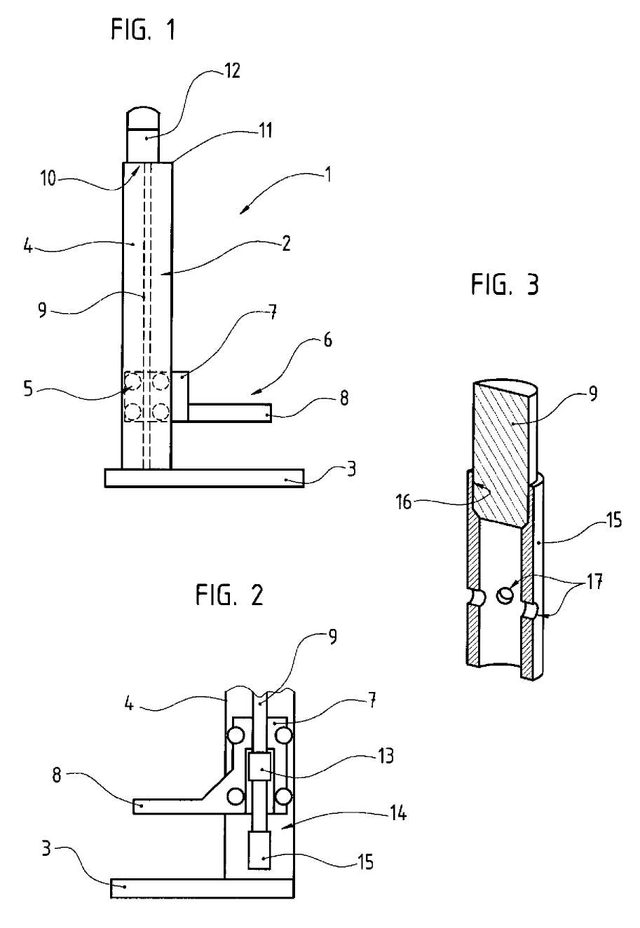

As shown in FIG. 1 of the attached drawing, the present invention relates to a hoisting device 1, usually referred to as lifting column because of its frame 2, which is primarily formed by a base plate 3 topped by a vertically arranged guiding rail 4.

On this guiding rail 4 are movably fitted, namely thanks to adapted rolling elements, lifting means 6 in the form of a carriage 7 comprising in the front portion 1 several lifting arms 8 on which the load to be lifted is designed capable of resting.

Inside the guiding rail 4, often having a U-shaped general structure, vertically extends a threaded rod 9, which is shown in FIG. 2. The latter is hung, through its upper end 10, from the column head 11. In particular, this threaded rod 9 is rotationally mounted at the level of this column head 11, which also receives an electric driving motor 12 designed capable of acting on said threaded rod 9 in order to subject it to a rotation from which results the lifting and the lowering of the carriage. In fact, the latter is provided with a nut 13 fitted on said threaded rod 9.

In particular, according to the invention, this threaded rod 9 is provided, at its lower end 14, with an extension ferrule 15. As can be seen in FIG. 3, the latter is retractably inserted on this lower end 14 of the threaded rod 9.

Thus, though this extension ferrule 15 permits to extend this threaded rod 9, substantially over the full height of the column, so as to avoid a too important fall of the lifted load, it can nevertheless, in the event of breaking of said rod 9, be dismantled to allow an easy replacing of the wearing part, which the nut 13 corresponds to. Indeed, after removing this extension ferrule 15, there is sufficient room to authorize the removal of the nut 13 from the lower end 14 of said threaded rod 9.

Finally, though this extension ferrule 15 can be defined of a minimum height in order to allow this operation of removing the nut 13, it can also extend substantially over the full height between the lower end of the useful portion of the threaded rod 9 and the base plate 3, even the floor on which rests the hoisting device 1.

According to an exemplary embodiment, the extension ferrule 15 includes an inner thread 16 for its mounting through screwing onto the lower end 14 of the threaded rod 9. This extension ferrule 15 also includes means for controlling the rotation 17, for example in the form of openings into which can be inserted a tool in order to ensure the screwing and unscrewing operations. Of course, other removable connecting means can be contemplated. In particular, it can be contemplated to make this extension ferrule integral with the end of the threaded rod, after encasing on the latter, by means of pins, snap rings or the like.

As regards the dimensioning of the extension ferrule 15, it should also be noted that the latter is defined of such a length that, after screwing or encasing it onto the lower end 14 of the threaded rod 9, sufficient free space is preserved, under this extension ferrule 15, to allow its unscrewing or its bringing out of encasement with a view to its removal.

It should however be noted that this free space will, in all the cases, be chosen smaller than the maximum drop height laid on by the standards in the field.

As already mentioned above, this extension ferrule 15 will also be dimensioned so as to guarantee a perfect support of the lifted load in the event of an accidental breaking of the threaded rod 9.

Finally, as results from the preceding description, the present invention solves in a clever way the problem raised until now by the replacement of the wearing part corresponding to the nut on this type of hoisting device in the form of a column.

1. Hoisting device, in particular for a vehicle, including a substantially vertical column forming a frame and lifting means movable alongside said column under the action of the control, by adequate driving means, to cause a threaded rod to rotate and a nut integral with said movable lifting means on which the load to be lifted is designed capable of resting to move along the latter, wherein the threaded rod includes, at its lower end, a removable extension ferrule.

2. Hoisting device according to claim 1, wherein the extension ferrule includes an inner thread for its cooperation with the lower end of the threaded rod.

3. Hoisting device according to claim 1, wherein the extension ferrule includes means for controlling the rotation.

4. Hoisting device according to claim 3, wherein the means for controlling the rotation are formed by openings provided for in the extension ferrule.

5. Hoisting device according to claim 1, wherein the extension ferrule is designed capable of being encased onto the lower end of the threaded rod.

6. Hoisting device according to claim 1, wherein the extension ferrule is defined of such a length that, after screwing or encasing it onto the lower end of the threaded rod, sufficient free space is preserved, under this extension ferrule, to allow its unscrewing or its bringing out of encasement with a view to its removal.

7. Hoisting device according to claim 1, wherein the extension ferrule is defined of such a length that after having been removed, it leaves sufficient space to authorize the removal of the nut from the lower end of said threaded rod.

8. Hoisting device according to claim 2, wherein the extension ferrule includes means for controlling the rotation.

9. Hoisting device according to claim 8, wherein the means for controlling the rotation are formed by openings provided for in the extension ferrule.

10. Hoisting device according to claim 2, wherein the extension ferrule is defined of such a length that, after screwing or encasing it onto the lower end of the threaded rod, sufficient free space is preserved, under this extension ferrule, to allow its unscrewing or its bringing out of encasement with a view to its removal.

11. Hoisting device according to claim 3, wherein the extension ferrule is defined of such a length that, after screwing or encasing it onto the lower end of the threaded rod, sufficient free space is preserved, under this extension ferrule, to allow its unscrewing or its bringing out of encasement with a view to its removal.

12. Hoisting device according to claim 4, wherein the extension ferrule is defined of such a length that, after screwing or encasing it onto the lower end of the threaded rod, sufficient free space is preserved, under this extension ferrule, to allow its unscrewing or its bringing out of encasement with a view to its removal.

13. Hoisting device according to claim 5, wherein the extension ferrule is defined of such a length that, after screwing or encasing it onto the lower end of the threaded rod, sufficient free space is preserved, under this extension ferrule, to allow its unscrewing or its bringing out of encasement with a view to its removal.

14. Hoisting device according to claim 2, wherein the extension ferrule is defined of such a length that after having been removed, it leaves sufficient space to authorize the removal of the nut from the lower end of said threaded rod.

15. Hoisting device according to claim 3, wherein the extension ferrule is defined of such a length that after having been removed, it leaves sufficient space to authorize the removal of the nut from the lower end of said threaded rod.

16. Hoisting device according to claim 4, wherein the extension ferrule is defined of such a length that after having been removed, it leaves sufficient space to authorize the removal of the nut from the lower end of said threaded rod.

17. Hoisting device according to claim 5, wherein the extension ferrule is defined of such a length that after having been removed, it leaves sufficient space to authorize the removal of the nut from the lower end of said threaded rod.

18. Hoisting device according to claim 6, wherein the extension ferrule is defined of such a length that after having been removed, it leaves sufficient space to authorize the removal of the nut from the lower end of said threaded rod.
